(19) United States
(12) Patent Application Publication
(10) Pub. No.: US 2017/0176642 A1
(43) Pub. Date: Jun. 22, 2017

(54) CONTACT LENS MATERIAL

(71) Applicant: DEALTFORCE LIMITED, Romsey (GB)

(72) Inventors: Andrew Courtis, Frodsham (GB); Peter W J Morrison, Chapelford Village (GB)

(73) Assignee: DEALTFORCE LIMITED, Romsey (GB)

(21) Appl. No.: 15/115,424

(22) PCT Filed: Mar. 6, 2015
(86) PCT No.: PCT/GB2015/050650

§ 371 Date: Jul. 29, 2016

(30) Foreign Application Priority Data
Mar. 6, 2014 (GB) 1403978.8

(51) Int. Cl. G02B 1/04; C08F 220/28; B29D 11/00; G02C 7/04

(52) U.S. Cl. CPC G02B 1/043; G02C 7/049; C08F 220/28; B29D 11/00038; C08F 2220/282; B29K 2083/00

(57) ABSTRACT

The present invention relates to contact lenses, contact lens materials, and a method of manufacturing a contact lens material comprising:
(i) providing a composition comprising:
   i. a tris(siloxy)silyl group-containing monomer and/or a tetrakis(siloxy)disiloxane monomer; and
   ii. a polymeric monomer having the formula:

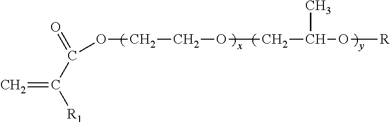

iii. wherein R═H, alkyl or aryl; R₁═H or alkyl; x can be 0 if y is an integer; and y can be 0 if x is an integer; and
(ii) curing the composition.

### REFERENCE TO RELATED APPLICATIONS

This is a US national stage application of PCT/GB2015/050650 filed Mar. 6, 2015, claiming priority to GB 1403978.8 filed Mar. 6, 2014, the entire disclosures of which are expressly incorporated herein by reference.

### FIELD OF THE INVENTION

The invention relates to a method of manufacturing a contact lens material and a contact lens material manufactured according to the method.

### BACKGROUND OF THE INVENTION

Contact lenses may generally be classified into two categories; rigid or soft. Each involves different chemistry in their production. Rigid lenses are inflexible acrylic devices. This material is durable and has excellent optical properties with high refractive index. Therefore the finished lenses are thin, hardwearing and may last significantly longer than soft lenses.

Soft contact lenses are manufactured from polymers that are capable of imbibing water; such polymers are known as hydrogels. Soft lenses were primarily developed as a result of the discovery of poly(2-hydroxyethyl methacrylate). Soft lenses have improved with the development/incorporation of a broad range of monomers. In particular, the use of silicone hydrogels has vastly improved the oxygen permeability of soft lenses since their introduction in 1998. Hydrogels of all types include hydrophilic monomers in order to give lenses water absorbing properties and thus the material becomes soft and has a hydrophilic surface. Contact lenses made of this class of material generally offer comfort due to their softness, but they are less durable and have a lower refractive index due to the water content. Therefore they tend to be thicker compared with rigid gas permeable contact lenses.

U.S. Pat. No. 5,770,669 teaches the use co-polymers of silicones and dimethacrylates of polyalkylene glycols in hydrogels for soft contact lenses. It further teaches the use of hydrophilicity-modifying monomers to improve the hydrophilicity of the polymer.

US2009/0190090 discloses a method for forming a soft silicone hydrogel contact lenses.

A rigid lens is able to replace the natural shape of the cornea with a new refracting surface. This means that a spherical rigid contact lens can correct for astigmatism. Rigid lenses can also be made as a front-toric, back-toric, or bitoric. This is different from a spherical lens in that one or both surfaces of the lens deliver a toric correction. Rigid lenses are more chemically inert, allowing them to be worn in more challenging environments than soft lenses.

Rigid contact lenses made from poly-methyl methacrylate (PMMA) give the wearer a poor experience because of the low oxygen permeability and poor surface wettability. Attempts were made to improve the wettability of PMMA materials by copolymerisation with hydrophilic monomers such as hydroxyethyl methacrylate (HEMA). U.S. Pat. No. 3,948,871 describes how when HEMA is incorporated at the 10% level a good balance of stability and wettability can be achieved. However, the problem of low oxygen permeability remains.

The field of rigid contact lens materials was revolutionised in the early 1970s by the introduction of polysiloxanylalkyl acrylic esters into the matrix with methyl methacrylate in order to increase oxygen permeability (see U.S. Pat. No. 3,808,178). The incorporation of bulky silicon containing monomers such as TRIS ((3-methacryloxypropyl) tris (trimethylsiloxy)silane) resulted in high levels of oxygen permeability but also imparted a hydrophobic nature to the rigid gas permeable (RGP) lens surface which reduced the ease of wetting.

Methacrylic acid was adopted as a “wetting agent” for RGP material formulations and has continued to find use in modern contact lens formulations. However, whilst imparting some hydrophilic nature to the surface, the carboxylic acid groups are buried amongst the bulkier TRIS groups and thus only provide a limited effectiveness.

The use of HEMA as a wetting agent has been adopted in some current RGP material ranges (roflufocon). However, unlike in the case of copolymers with MMA where the hydroxyethyl group was sterically predominant on the lens surface, in combination with TRIS the hydroxyethyl groups are buried by the bulkier silicon groups.

Similar limitations are found with RGP formulations which combine HEMA and GMA (2,3,-dihydroxypropyl 2-methyl-2-propenoate) such as hybufocon.

An interesting approach in providing wettability was adopted by the Lagado Corporation. Onsifocon incorporated a TRIS type monomer which hydrolysed when exposed to packaging solution. 3-trimethoxysilyl propyl methacrylate provided a hydroxylated moiety with a relatively high exposure on the lens surface. To date, this formulation approach has proved to be most effective in providing wettability to a material which can be made into a contact lens.

Other approaches to providing wettability to an RGP lens involve surface treatments of a manufactured lens. Plasma oxidation is a currently employed technique, and patents have been granted for the grafting of HEMA PC (U.S. Pat. No. 5,453,467) and polyethylene glycol (U.S. Pat. No. 6,599,559) onto the surface of an RGP lens in order to provide exceptional wettability. However, surface treatments increase the complexity of the manufacturing process and are, therefore, economically unfavourable.

U.S. Pat. No. 4,822,864 discloses a method of producing rigid contact lens materials comprising 3-methacryloxypropytris(trimethylsiloxy) silane, methacrylic acid, cyclohexylmethacrylate, 2-hydroxypropylmethacrylate, m,p-styrylethyltrimethoxysilane, methyl methacrylate and a cross-linker and a treatment to improve surface hydrophilicity.

U.S. Pat. No. 3,808,178 discloses contact lenses fabricated from a co-polymer of polysiloxanylalkyl acrylic ester and an alkyl acrylic ester. It teaches that such contact lenses have increased oxygen permeability.

It is worth noting that although hydrophilic monomers are incorporated into both rigid and soft lenses it is understood in the art that they serve different purposes. The incorporation of hydrophilic monomers in the formulations of soft lenses gives water absorbing properties and thus the material becomes soft and has a hydrophilic surface. Conversely, inclusion of hydrophilic monomers in rigid lenses is in order to improve the wettability of the lens surface.

That is, rigid and soft lenses can generally be distinguished by the quantity of hydrophilic monomer and difunctional cross-linker incorporated. Hydrogel compositions for soft lenses generally include at least 25% hydrophilic monomer and very low quantities of cross-linker (typically less than 5%, more preferably less than 1%). This enables the formation of an open matrix that can be swollen by water. Conversely, rigid lens compositions generally include lower quantities of hydrophilic monomer and relatively high quantities of difunctional cross-linker. The low proportion of hydrophilic monomer may improve surface wettability without swelling of the matrix in water, while the increased cross linker prevents swelling of the matrix in water.

### SUMMARY OF THE INVENTION

The present invention seeks to tackle at least some of the problems associated with the prior art or at least to provide a commercially acceptable alternative solution thereto.

In a first aspect the present invention provides a method of manufacturing a contact lens material comprising:

(i) providing a composition comprising:
i. a tris(siloxy)silyl group-containing monomer and/or a tetrakis(siloxy)disiloxane monomer; and
ii. a polymeric monomer having the formula:

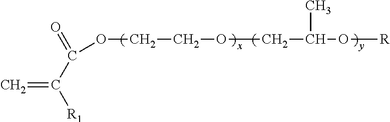

iii. wherein R═H, alkyl or aryl; R₁═H or alkyl; x can be 0 if y is an integer; and y can be 0 if x is an integer; and

(ii) curing the composition.

Each aspect or embodiment as defined herein may be combined with any other aspect(s) or embodiment(s) unless clearly indicated to the contrary. In particular, any features indicated as being preferred or advantageous may be combined with any other feature indicated as being preferred or advantageous.

R and R₁ are independently selected from the recited lists.

### BRIEF DESCRIPTION OF THE FIGURE

FIG. 1 is a schematic representation of three main steps in the process aspect of the invention.

### DETAILED DESCRIPTION OF PREFERRED EMBODIMENTS

The term “contact lens material” as used herein may encompass a material capable of being employed in a contact lens.

The term “alkyl” as used herein may encompass a univalent group derived from an alkane by removal of a hydrogen atom from any carbon atom —CₙH₂ₙ₊₁. The alkyl group may be branched or linear, and may be substituted or unsubstituted. In the present application, the alkyl groups typically comprise from one to six carbon atoms.

The term “aryl” used herein may encompass a group derived from an arene by removal of a hydrogen atom from a ring carbon atom. The aryl group may be substituted or unsubstituted. In the present application, the aryl groups typically comprise from five to seven carbon atoms, more typically six carbon atoms.

The term “tris(siloxy)silylgroup-containing monomer” as used herein may encompass a monomer with a group having the formula:

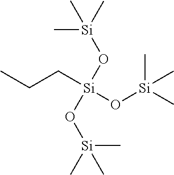 [SMILES: CCC[Si](O[Si](C)(C)C)(O[Si](C)(C)C)O[Si](C)(C)C]

The term “(3-methacryloxypropyl)tris(trimethylsiloxy)silane” used herein may encompass a compound having the formula:

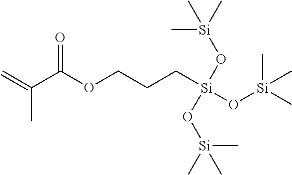 [SMILES: C=C(C)C(=O)OCCC[Si](O[Si](C)(C)C)(O[Si](C)(C)C)O[Si](C)(C)C]

The term “tetrakis(siloxy) disiloxane group-containing monomer” as used herein may encompass a monomer with a group having the formula:

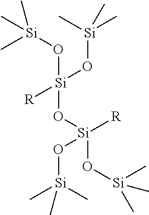

The term “1,3-bis(methacryloxypropyl)-1,1,3,3-tetrakis(trimethyl siloxy)disiloxane” used herein may encompass a compound having the formula:

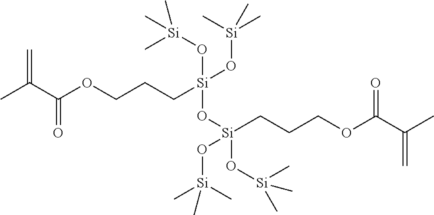 [SMILES: C=C(C)C(=O)OCCC[Si](O[Si](C)(C)C)(O[Si](C)(C)C)O[Si](CCCOC(=O)C(=C)C)(O[Si](C)(C)C)O[Si](C)(C)C]

The term “polyethylene glycol methyl ether methacrylate” used herein may encompass a polymer having the formula:

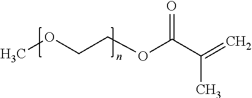

The term “azo isobutyronitrile” used herein may encompass a compound having the formula:

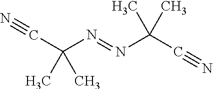

The inventors have surprisingly found that the surface of the material manufactured by the method exhibits improved wettability. For example, the surface of the material typically exhibits a wetting angle of less than 80 degrees with distilled water, more typically less than 65 degrees, even more typically less than 55 degrees when measured using a GBX Digidrop MCAT. Without being bound by theory, it is considered that the high wettability of the material surface is a result of the high hydrophilicity of the polymeric monomer. It is considered that, in contrast to prior art contact lens materials, the hydrophilic groups of the polymeric monomer are not substantially buried amongst the bulky tris groups. The contact lens material manufactured according to this method also exhibits high oxygen permeability, typically with an ISO/Fatt Dk value of from 25 to 140. Without being bound by theory, it is considered that this high oxygen permeability is due to the presence of the tris(siloxy)silyl group-containing monomer.

Contact lenses formed of the material may result in increased levels of tear spreading and decreased levels of deposits in use. This is due to the high ease of wetting of the material. Accordingly, the comfort experienced by the wearer is increased and, consequently, the contact lenses may be worn for longer period of time. As a result of the high oxygen permeability, oxygen is transmitted through the lens to the conjunctiva and cornea in use, thereby reducing the occurrence of a number of adverse clinical effects. The combination of high ease of wetting and high oxygen permeability results in a contact lens exhibiting both high levels of comfort and high levels of safety.

Advantageously, the method does not require a surface treatment in order to render the surface of the material hydrophilic. This results in a simplified, more economical manufacturing method.

The polymeric monomer is preferably polyethylene glycol methyl ether methacrylate. Polyethylene glycol methyl ether methacrylate may provide the surface of a formed contact lens with particularly improved wettability, presumably due to its high hydrophilicity.

The polymeric monomer typically has a number average molecular weight of greater than 200, more typically from 250 to 1000, even more typically from 300 to 500, still even more typically about 475. Such molecular weights may provide the surface of a formed contact lens with particularly improved wettability, since the hydrophilic groups will not be buried amongst the bulky tris groups. In addition, monomers with such molecular weights are convenient to handle during the manufacturing method.

The polymeric monomer is preferably present in an amount up to 20% by weight based on the total weight of the composition, more preferably from 1 to 5% by weight, even more preferably about 2.5% by weight. Lower levels of polymeric monomer may result in the contact lens exhibiting unsatisfactory wettability. Higher levels of polymeric monomer may result in the contact lens exhibiting unsatisfactory oxygen permeability and stability.

The tris(siloxy)silyl group-containing monomer is preferably an ester of methacrylic acid, more preferably the tris(siloxy)silyl group-containing monomer is (3-methacryloxypropyl)tris(trimethylsiloxy)silane. Such monomers may provide the contact lens with particularly favourable levels of oxygen permeability.

Tris(siloxy)silyl group-containing monomer may undergo dimerization to yield difunctional dimers.

Preferably the tetrakis(siloxy)disiloxane group-containing monomer is a diester of methacrylic acid. Such dimers may act as a difunctional cross linker to provide contact lens with favourable levels of rigidity. Preferably the composition further comprises 1,3-bis(methacryloxypropyl)-1,1,3,3-tetrakis(trimethyl siloxy)disiloxane.

Preferably the composition comprises the tris(siloxy)silyl group-containing monomer and the tetrakis(siloxy)disiloxane group-containing monomer. Preferably the weight ratio of the tris(siloxy)silyl group-containing monomer to the tetrakis(siloxy)disiloxane group-containing monomer is from 9:1 to 1:1, preferably from 4:1 to 3:4, and most preferably about 7:3.

Preferably, the composition further comprises an initiator. Initiators may help to promote the polymerisation reaction. Initiators are known in the art. Azo isobutyronitrile is a particularly effective initiator.

Preferably, the composition further comprises a fluorinated monomer. The presence of a fluorinated monomer may increase the oxygen permeability of the material and reduce the surface friction of lenses, thus reducing their tendency to form deposits. Accordingly, a contact lens formed of the material may be more comfortable for a wearer. Tetrafluoropropyl methacrylate is a particularly suitable fluorinated monomer.

The composition preferably further comprises an alkyl or aryl acrylate or methacrylate, typically methyl methacrylate. These species may increase the rigidity and refractive index of the contact lens material surface.

The composition further comprises acrylic acid, preferably methacrylic acid. These species may increase the wettability of the contact lens material surface.

In a preferred embodiment, the composition comprises, by weight:
from 1 to 5% polymeric monomer; and/or
from 38 to 46% tris(siloxy)silyl group-containing monomer and/or
from 16 to 20% tetrakis(siloxy)disiloxane; and/or
from 0.1 to 0.5% initiator; and/or
from 15 to 25% fluorinated monomer.

In a particularly preferred embodiment, the composition comprises, by weight:
about 2.5% polyethylene glycol methyl ether methacrylate;
about 41% (3-methacryloxypropyl)tris(trimethylsiloxy)silane;
about 17% 1,3-bis(methacryloxypropyl)-1,1,3,3-tetrakis(trimethyl siloxy)disiloxane;
about 0.2% azo isobutyronitrile;
about 20% tetrafluoropropyl methacrylate;
about 12% methyl methacrylate; and
about 7% methacrylic acid.

Curing techniques are known in the art and may comprise, for example, the application of heat and/or UV.

The curing is preferably carried out under an inert atmosphere, more preferably nitrogen. This may avoid any undesirable degradation of the monomer species during curing.

The curing is preferably carried out at a temperature of from 30 to 80° C., more preferably about 50° C. Lower temperatures may require a particularly long curing time. Higher temperatures may be uneconomical and/or may result in degradation of the monomers.

The curing is preferably carried out for at least 10 hours, more preferably from 24 to 72 hours, even more preferably about 48 hours. Shorter curing times may result in inadequate curing of the composition. Longer curing times may be uneconomical and may result in degradation of the composition.

The method may further comprise a post curing treatment. The post curing treatment may comprise, for example, heating at a temperature of from 75 to 90° C. for from 1 to 10 hours.

The method may further comprise annealing the composition. The annealing may be carried out at a temperature of from 95 to 105° C. for from 4 to 12 hours.

In a further aspect the present invention provides a method of manufacturing a contact lens comprising:

manufacturing a contact lens material according to the method described herein; and

forming the contact lens material into the shape of a contact lens.

The step of forming the contact lens material may comprise lathing and/or moulding. Such techniques are known in the art.

In one embodiment the step of curing is carried out after the step of forming the contact lens material into the shape of a contact lens; and forming the contact lens material into the shape of a contact lens is carried out by introducing the composition into a contact lens mould.

The method may further comprise carrying out a surface treatment on the contact lens, such as, for example, a plasma treatment. However, the intrinsic wettability of lenses made according to the current invention largely makes such treatment unnecessary.

In a further aspect the present invention provides a contact lens material manufactured according to the method described herein.

In a further aspect the present invention provides a contact lens manufactured according to the method described herein.

The contact lens may be a rigid gas permeable contact lens.

In a further aspect the present invention provides a contact lens-form ing composition for use in the method described herein comprising:

a tris(siloxy)silyl group-containing monomer and/or a tetrakis(siloxy)disiloxane monomer; and

a polymeric monomer having the formula:

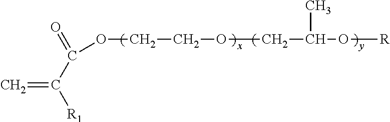

wherein: R═H, alkyl or aryl; R₁═H or alkyl; x can be 0 if y is an integer; and

y can be 0 if x is an integer.

In a further aspect the present invention provides a contact lens material comprising the polymerisation product of:

a tris(siloxy)silyl group-containing monomer and/or a tetrakis(siloxy)disiloxane monomer; and

a polymeric monomer having the formula:

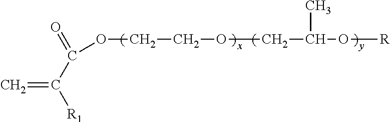

wherein: R═H, alkyl or aryl; R₁═H or alkyl; x can be 0 if y is an integer; and

y can be 0 if x is an integer. The present invention also provides a contact lens comprising this contact lens material.

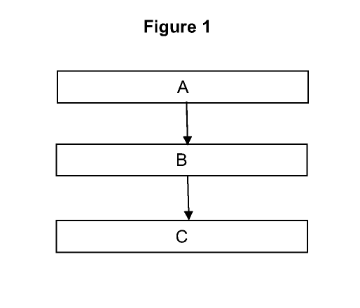

The process described herein is shown in the attached non-limiting FIG. 1, in which: Step A comprises filling a mould with the contact lens composition; Step B comprises curing the composition; and Step C involves lathing the cured lens to the final shape and size desired.

The invention will now be described in relation to the following non-limiting examples.

### Example 1—Preparation of Rigid Gas Permeable Material

A mixture was prepared having the composition set out in Table 1.

TABLE 1

| Component | Parts (by weight) |
|---|---|
| Methyl methacrylate | 12.25 |
| Methacrylic acid | 6.8 |
| Tetrafluoropropyl methacrylate | 19.98 |
| ((3-methacryloxypropyl) tris | 58.25 |
| (trimethylsiloxy)silane wherein | |
| about 30% exists as its dimer 1,3- | |
| bis(methacryloxypropyl)-1,1,3,3- | |
| tetrakis(trimethyl siloxy)disiloxane | |
| Polyethylene glycol methyl ether | 2.5 |
| methacrylate | |
| Mn = 475 | |
| Azo isobutyronitrile | 0.22 |

The mixture of Table 1 was stirred and degassed and dispenses into 16 mm diameter polypropylene tubes under nitrogen and capped. The tubes were placed in a water bath for 48 hours at 50° C. The tubes were then post cured at 85° C. for 4 hours then annealed at 100° C. for 8 hours.

The tubes were ground and sliced into buttons with dimensions 12.7 mm by 5 mm which were then lathed to form RGP contact lenses.

### Comparative Example 2—Preparation of Rigid Gas Permeable Material

A mixture was prepared having the composition set out in Table 2.

TABLE 2

| Component | Parts (by weight) |
|---|---|
| Methyl methacrylate | 13.5 |
| Methacrylic Acid | 6.8 |
| Tetrafluoropropyl methacrylate | 19.98 |
| ((3-methacryloxypropyl) tris | 59.5 |
| (trimethylsiloxy)silane wherein | |
| about 30% exists as its dimer 1,3- | |
| bis(methacryloxypropyl)-1,1,3,3- | |
| tetrakis(trimethyl siloxy)disiloxane | |
| Azo isobutyronitrile | 0.22 |

The mixture of Table 2 was stirred and degassed, dispensed into 16 mm diameter polypropylene tubes under nitrogen and capped. The tubes were placed in a water bath for 48 hours at 50° C. The tubes were then post cured at 85° C. for 4 hours then annealed at 100° C. for 8 hours.

The tubes were ground and sliced into buttons with dimensions 12.7 mm by 5 mm which were then lathed to form RGP contact lenses.

Wetting angle of lenses made from Example 1 and Comparative Example 2:

All lenses made by Acuity Contact Lenses UK

(same machine, same diamond, same day)

Measurements were carried out using a GBX Digidrop MCAT using distilled water, and the results are set out in Table 3.

TABLE 3

| Material | Wetting angle |
|---|---|
| Example 1 | 52° |
| Example 2 | 83° |

Clinical studies on lenses made from the Example 1 formulation

### Case 1:

A patient had historically suffered from a serious problem with lens deposits. Contact lenses made of different prior art materials were systematically tried (including the Boston range). However, in each case the patient managed to wear their lenses for no longer than 2 weeks before replacements were necessary due to massive amounts of deposit build-up.

Contact lenses formed of the material of Example 1 were prepared. After four weeks of wear, the patient presented with a lens that was still very wearable, something that was previously impossible with all of the well-known RGP materials. In addition, the patient indicated that the comfort was so great that she felt as if she did not have lenses in at all.

### Case 2:

A male patient complained of difficult vision with both eyes open. (Best-corrected spectacle acuity right 6/48, left 6/6+). After discussion with the patient, his reason for not continuing with his previous RGP's was extreme discomfort and inability to increase his wear time to anything over an hour or so.

Lenses formed of the Example 1 material in the Acuity KC design were tried. Immediately after insertion of these lenses he commented on how comfortable they were. He was extremely impressed with the level of comfort and felt that there was a huge improvement when compared to his previous lenses. In fact, within only a couple of minutes the lenses appeared to have settled and there was hardly any tearing—which was not at all what was expected from a patient with this particular history.

Best corrected acuity is now excellent in each eye (R 6/6+, L 6/6) and the patient found the lenses extremely easy to handle. He feels that he will be able to build up wear time to a full day now that he has a pair of lenses that are comfortable immediately on insertion.

Unless otherwise stated, all percentages recited herein are by weight. Unless otherwise stated, all “integers” are natural numbers.

The foregoing detailed description has been provided by way of explanation and illustration, and is not intended to limit the scope of the appended claims. Many variations in the presently preferred embodiments illustrated herein will be apparent to one of ordinary skill in the art and remain within the scope of the appended claims and their equivalents.

1. A method of manufacturing a contact lens material comprising:
(i) providing a composition comprising:
a tris(siloxy)silyl group-containing monomer and/or a tetrakis(siloxy)disiloxane monomer; and
a polymeric monomer having the formula: 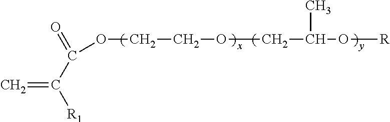
wherein R═H, alkyl or aryl; R₁═H or alkyl; x can be 0 if y is an integer;
and y can be 0 if x is an integer; and
(ii) curing the composition.

2. The method of claim 1, wherein the contact lens material is for a rigid gas permeable contact lens.

3. The method of claim 1, wherein R and R₁ are both methyl.

4. The method of claim 1, wherein y=0.

5. The method of claim 1, wherein the polymeric monomer is polyethylene glycol methyl ether methacrylate.

6. The method of claim 1, wherein:
(i) the tris(siloxy)silyl group-containing monomer is an ester of methacrylic acid, preferably the tris(siloxy)silyl group-containing monomer is (3-methacryloxypropyl)tris(trimethylsiloxy)silane; and/or
(ii) the tetrakis(siloxy)disiloxane group-containing monomer is a diester of methacrylic acid, preferably the tetrakis(siloxy)disiloxane group-containing monomer is 1,3-bis(methacryloxypropyl)-1,1,3,3-tetrakis(trimethyl siloxy)disiloxane.

7. The method of any preceding claim, wherein the composition comprises the tris(siloxy)silyl group-containing monomer and the tetrakis(siloxy)disiloxane group-containing monomer.

8. The method of claim 7, wherein the weight ratio of the tris(siloxy)silyl group-containing monomer to the tetrakis(siloxy)disiloxane group-containing monomer is from 9:1 to 1:1.

9. The method of claim 1, wherein the polymeric monomer has a molecular weight from 250 to 1000.

10. The method of claim 1, wherein the polymeric monomer is present in an amount up to 20% by weight based on the total weight of the composition.

11. The method of claim 1, wherein the composition further comprises an initiator comprising azo isobutyronitrile.

12. The method of claim 1, wherein the composition further comprises a fluorinated monomer.

13. The method of claim 1, wherein the composition further comprises one or more of methyl methacrylate and methacrylic acid.

14. The method of claim 1, wherein the composition further comprises, by weight:
from 1 to 5% polymeric monomer; and/or
from 38 to 46% tris(siloxy)silyl group-containing monomer; and/or
from 16 to 20% tetrakis(siloxy)disiloxane; and/or
from 0.1 to 0.5% initiator; and/or
from 15 to 25% fluorinated monomer.

15. The method of claim 1, wherein the composition further comprises, by weight:
about 2.5% polyethylene glycol methyl ether methacrylate;
about 41% (3-methacryloxypropyl)tris(trimethylsiloxy)silane
about 17% 1,3-bis(methacryloxypropyl)-1,1,3,3-tetrakis(trim ethyl siloxy)disiloxane;
about 0.2% azo isobutyronitrile;
about 20% tetrafluoropropyl methacrylate;
about 12% methyl methacrylate; and
about 7% methacrylic acid.

16. The method of claim 1, wherein the curing is carried out under an inert atmosphere.

17. The method of claim 1, wherein the curing is carried out at a temperature of from 30 to 80° C.

18. The method of claim 1, wherein the curing is carried out for from 24 to 72 hours.

19. The method of claim 1, further comprising a post curing treatment at a temperature of from 75 to 90° C. for from 1 to 10 hours.

20. The method of claim 1, further comprising annealing the composition at a temperature of from 95 to 105° C. for from 4 to 12 hours.

21. The method of claim 1 further comprising forming the contact lens material into the shape of a contact lens.

22. The method of claim 21, wherein forming the contact lens material comprises lathing.

23. The method of claim 21 wherein:
the step of curing is carried out after the step of forming the contact lens material into the shape of a contact lens; and
forming the contact lens material into the shape of a contact lens is carried out by introducing the composition into a contact lens mould.

24. The method of claim 23 further comprising carrying out a surface treatment on the contact lens.

25. (canceled)

26. (canceled)

27. A contact lens-forming composition for use in the method of claim 1 comprising:
a tris(siloxy)silyl group-containing monomer and/or a tetrakis(siloxy)disiloxane monomer; and
a polymeric monomer having the formula: 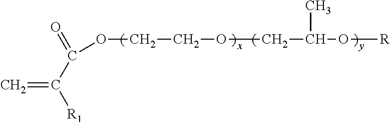
wherein: R═H, alkyl or aryl; R₁═H or alkyl; x can be 0 if y is an integer; and
y can be 0 if x is an integer.

28. A contact lens material comprising the polymerisation product of:
a tris(siloxy)silyl group-containing monomer and/or a tetrakis(siloxy)disiloxane monomer; and
a polymeric monomer having the formula: 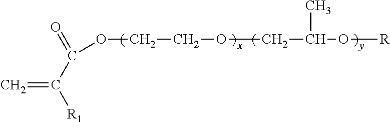
wherein: R═H, alkyl or aryl; R₁═H or alkyl; x can be 0 if y is an integer; and
y can be 0 if x is an integer.
